(19) United States
(12) Patent Application Publication
(10) Pub. No.: US 2010/0223594 A1
(43) Pub. Date: Sep. 2, 2010

(54) Method and apparatus for implementing a composable control architecture

(75) Inventors: Alexander Kartavov, East Windsor, NJ (US); Anthony Lombardo, Princeton, NJ (US); Stephen Zaharuk, Bensalem, PA (US); Don Preuninger, Allentown, NJ (US)

Correspondence Address: RAYMOND R. MOSER JR., ESQ.;MOSER IP LAW GROUP, 1030 BROAD STREET, SUITE 203, SHREWSBURY, NJ, 07702, US

(73) Assignee: INFRAGISTICS INC.

(21) Appl. No.: 12/380,446

(22) Filed: Feb. 27, 2009

(51) Int. Cl. G06F 9/44

(52) U.S. Cl. 717/106; 717/107

(57) ABSTRACT

A method and apparatus for generating a composed control. The method comprises selecting one or more functional modules, coupling the one or more selected functional modules to a core control, and generating scripted code that, when executed, implements the functionality of the core control and selected functional modules.

### BACKGROUND OF THE INVENTION

1. Field of the Invention

Embodiments of the present invention generally relate to computer code generation and, more particularly, to a method and apparatus for generating scripted controls used in, for example, website design.

2. Description of the Related Art

As website design technology matures and high speed internet access becomes ubiquitous, dynamic web pages have become increasingly common. These pages are often generated by request as a result of user queries, log in credentials, or other inputs. To provide these interactive services, various software languages, design frameworks, and development suites have been created. By using these technologies, the web author can generate software that, when executed by a web server application, provides a remote user with an interactive web experience.

In a dynamic web page, a server may provide a remote user with a series of individual software modules rather than a static file representing the entire page. These modules then allow the user to dynamically interact with the page without the need to reload the entire page for any changes or requests. In order to save the web developer time, modules implementing common functionality are often included as presets in web authoring tools. Additionally, by providing robust functionality in pre-determined modules, the developer does not necessarily need an intimate knowledge of the language used to develop the modules.

However, these advantages come with a trade off. Because these modules are general purpose, they are not tailored to a specific application. They may include numerous design features for which the web developer has no need. This results in larger file sizes, which translate to an increased load on both the server and the user's computer. Further, various options and properties representing the different possible functionalities may clutter a display or confuse a developer. Finally, additional functionality not provided by the provided properties of a module may be desirable. It would be advantageous if there was a way to provide a set of modules that were custom-tailored to a specific task, optimized to include no unnecessary functionality, and extensible to allow a user to add their own custom behaviors. Therefore, there is a need in the art for a method and apparatus for implementing a composable control architecture for designing websites.

### SUMMARY OF THE INVENTION

An embodiment of the present invention comprises a method and apparatus for implementing a composable control architecture. The method comprises selecting one or more functional modules, coupling the functional modules to a core control, and generating scripted code representing the core control with only the functionality provided by the one or more functional modules.

The apparatus comprises a computer readable storage medium containing instructions that cause a computer to execute a method for implementing a composable control architecture. The method comprises selecting one or more functional modules, coupling the functional modules to a core control, and generating scripted code representing the core control with only the functionality provided by the one or more functional modules.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting a computer in which an embodiment of the present invention is used;

FIG. 2 is a flow diagram of a method for implementing a composable control architecture;

FIG. 3 is a block diagram depicting an embodiment of a composed control used in the present invention;

FIG. 4 is a table depicting exemplary core controls and functional modules for controls implemented with an embodiment of the present invention;

FIG. 5 is a table depicting exemplary core controls and event points for controls implemented with an embodiment of the present invention;

FIG. 6 is an exemplary depiction of pseudocode representing a composed control creating using an embodiment of the present invention; and

FIG. 7 is an illustration depicting an application implementing an embodiment of the present invention.

### DETAILED DESCRIPTION

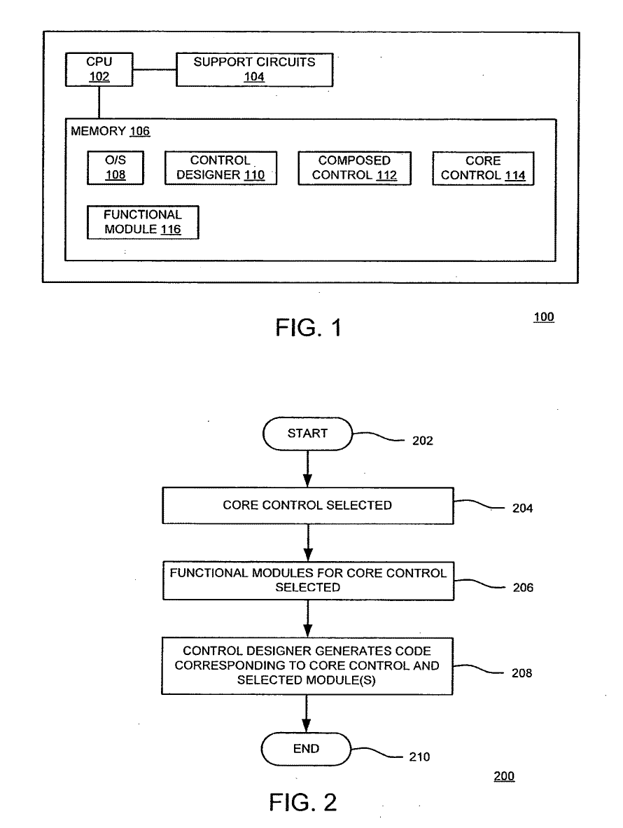

FIG. 1 is a block diagram depicting an embodiment of a general purpose computer that operates as a specific purpose computer 100 executing a control designer 110 containing an embodiment of the present invention. The general purpose computer is a computing device such as those generally known in the art. The specific purpose computer 100 includes a central processing unit (CPU) 102, support circuits 104, and memory 106. The CPU 102 may comprise one or more commercially available microprocessors or microcontrollers that facilitate data processing and storage. The various supporting circuits 104 are utilized to facilitate the operation of the CPU 102 and include such circuits as clock circuits, power supplies, cache, input/output circuits, and the like. The memory 106 may comprise random access memory, read only memory, removable storage, optical disk storage, disk drive storage, and combinations thereof. The memory 106 stores an operating system 108, a control designer 110, one or more composed controls 112, one or more core controls 114, and one or more functional modules 116. In operation, the CPU 102 executes the operating system 108 to control the general utilization and functionality of the host computer.

The memory 106 is also comprised of a control designer 110. When executed by the CPU 102, the control designer 110 causes the general purpose computer to behave as a specific purpose computer 100 for the purpose of creating optimized composed controls 112. The control designer 110 may be implemented as part of a web authoring suite. Such a web authoring suite allows a developer to create content that, when hosted via a server application, allows a user to interact with a web page. This content may be provided by any number of different web application frameworks, such as ASP.NET, COLDFUSION, PHP, and the like. While the present embodiment of the invention is discussed with respect to web design, a person of ordinary skill in the art of software development would recognize the broad applications of the invention with respect to any application with a client interface.

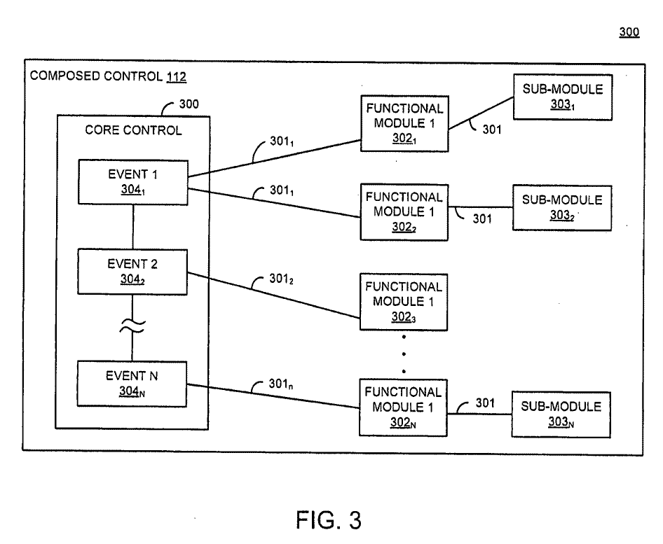

The memory 106 is further comprised of a composed control 112. The composed control 112 is an optimized control produced by the control designer 110. The core control 114 is a set of instructions representing base functionality for a module to be included in the completed web content. Examples of common core controls include buttons, menu bars, data grids, and the like. The functional module 116 represents optional functionality to be combined with the core control 114 to produce a composed control 112. The structure and design of the composed control 112, the core control 114, and the functional module 116 are discussed in further detail with respect to FIG. 3.

FIG. 2 is a flow diagram depicting an embodiment of a method for creating a composed control 112. The method begins at step 202, where the control designer 110 is executing and has transformed the computer into a special purpose device for creating a composed control 112. At step 204, the developer chooses from among a list of core controls 112. These core controls 112 represent sets of base functionality to be included in the completed web content. In one embodiment, the core controls 114 may be presented as a list in an integrated development environment (IDE) application. When the developer selects the core control 114 from a list of possible controls, the IDE application generates a body of code representing the implementation of that core control 114. The body of code may be implemented in a scripted language.

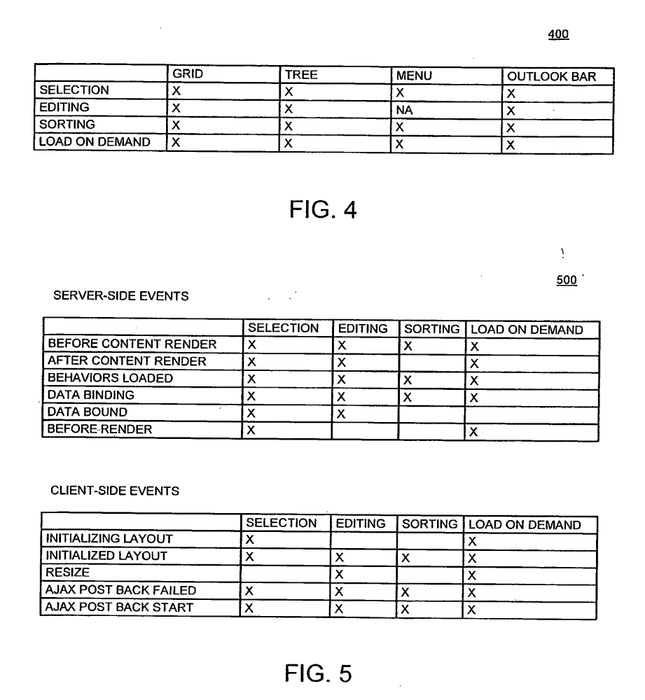

At step 206, the developer selects functional modules 116 to include with the core control 114. These functional modules 116 represent different optional behaviors for the core control 110. For example, the functional modules 116 may add a sort feature to a set of data, a scroll bar, the ability to select data members, or any other optional functionality. Additional functional modules and their core controls are discussed with respect to FIG. 4. The selection of functional modules may be implemented as a menu in the IDE application. The user may select from a list of possible functional modules represented as a check box list. As different functional modules 116 are chosen, the body of code for the core control is linked to sections of code representing the functionality of the chosen functional modules.

At step 208, the control designer 110 adds code corresponding to the functional modules 116 to the core control 110 to generate a composed control 112. The coupling of the modules may be represented in the IDE as subroutine calls appearing in the body of code representing the combined control. Each subroutine may correspond to one of the added functional modules. At step 210, the composed control 112 is complete and ready to be loaded to a hosting application for distribution.

FIG. 3 is a detailed depiction of an embodiment of a composed control 112. The composed control 112 is comprised of a core control 300 and one or more functional modules 302. The core control 300 may contain multiple event points 304. Each functional module 302 is bound to an event point 304. Multiple functional modules 302 may be bound to each event point. The functional modules 302 are bound to the event point by an event driven notification model. As each functional module 302 is created, conditions are specified for its execution. A given functional module 302 may have a specific condition when it is to be executed, or it may have multiple cases selectable by the developer. For example, a scroll bar functional module may only be executed when data contained within a grid exceeds the capacity of the grid to display it. When the grid is filled with data, the core control 300 generates a notification 301. The notification 301 contains data concerning the event that generated the notification 301. The notification 301 in this example contains data that indicates the grid has filled with data, and thus it triggers all functional modules 302 designed to execute when the grid is filled with data. In one embodiment, the notification process may be implemented as data members of the core control 300 which the functional module 302 is aware of. When an event occurs, the core control 300 modifies the data members corresponding to the event. The functional module 302 executes when the data member changes. In this case, this notification 301 would cause the scroll bar functional module to execute and create a scroll bar on the side of the data grid.

When an event 304 is reached during the rendering of the core control 300, the core control 300 sends a notification to alert the functional modules 302 bound to that event. The functional modules 302 listen for the events they are bound to, and execute when these events occur in the manner described above.

The functional modules 302 may have a hierarchy at the event point 304 to which they are bound. Each functional module 302 may act as a core module similar to the core control 300 and have a set of event points 304 associated with the core module.

In one embodiment, the functional modules 302 are executed at the event in the order they are selected by the developer. The functional modules 302 are notified of the event in the order the modules are connected to the core control 300. This natural order of notifications allows the developer to set priorities for connected functional modules.

Functional modules 302 are independent of the core control 300 and the core control 300 may not have access to any data or code contained within the modules.

The functional modules 302 may be provided by the control designer 110 as part of an IDE application or application suite, or they may be created by the developer. Functional modules 302 created by the developer may access the same events as those provided by the authoring tool, and participate in the same module hierarchy. The functional modules 302 may further be comprised of additional sub-modules. These sub-modules 303 may be further comprised of one or more sub-modules 303. The sub-modules 303 may modify the behavior of the functional modules 302. For example, a functional module 302 may add search functionality to a set of data, and a sub-module 303 may add the ability to page through the search results. Sub-modules 303 are indirectly coupled to the core control 300 through their parent functional module 302. The sub-modules 303 may be bound to the functional modules 302 by the same event driven notification model as the functional modules 302 are bound to the events 304 of the core control. The functionality for the sub-modules 303 is provided to the composed control 112 only as needed, in the same manner as that of the functional modules 302.

In one embodiment, the core control 300 and functional modules 302 are implemented as a series of scripts. In this implementation, the content may be sent to the user with a single script representing the core control 300 and individual scripts for each functional module 302, or the control designer 110 may combine the scripts into a single script to be sent. If the composed control 112 is generated in an IDE application as referenced in the above example, the IDE application may generate multiple scripts linked to one another for a web server application to host. The IDE application may also combine the multiple scripts into a single file to be hosted by the web server.

FIG. 4 is a table of exemplary functional modules for some common web controls. The examples given are intended to illustrate possible functionality which may be implemented via an embodiment of the present invention, but this table is not intended to limit the invention to the examples provided. Some examples of possible control types include data grids, data trees, selection menus, and the like.

FIG. 5 is a table of exemplary event points for some the functional modules listed described with respect to FIG. 4. As above, the examples given merely illustrate possible applications of an embodiment of the present invention, and are not intended to limit the invention to the examples provided. The event points may be differentiated into server-side events and client-side events. Client-side events may be triggered by a scripted API inside of a client web browser, while server-side events may be triggered by communication from a web server.

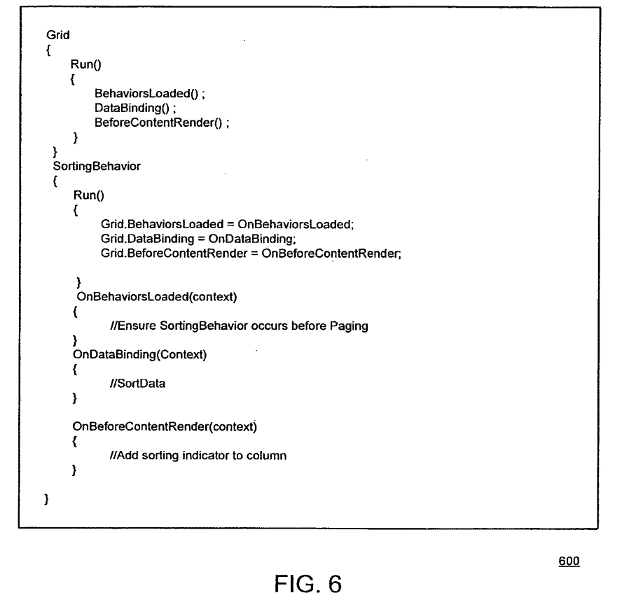

FIG. 6 is a depiction of an exemplary pseudocode implementation of a composed control 112 for a data grid with functional modules 116 enabling sorting behavior. The functional modules 116 may be self contained or multiple functional modules may represent a single behavior. Examples of behaviors include enabling data selection, data sorting, data editing, enabling load on demand functionality, and the like. One exemplary behavior that may be implemented as multiple functional modules 116 is the sorting behavior. In the example, a functional module 116 for the sorting behavior is bound to the “OnBehaviorsLoaded” event, which occurs when the functional modules 116 are first associated with the core control 114. This functional module executes to ensure that any sorting of data occurs prior to any paging of the data. When data is bound to the data grid, the “OnDataBinding” event occurs, notifying the next functional module 116 to sort the newly bound data. Before the grid display is rendered, the “OnBeforeContentRender” event occurs and the last functional module 116 adds a sort indicator to the grid's sorted column header.

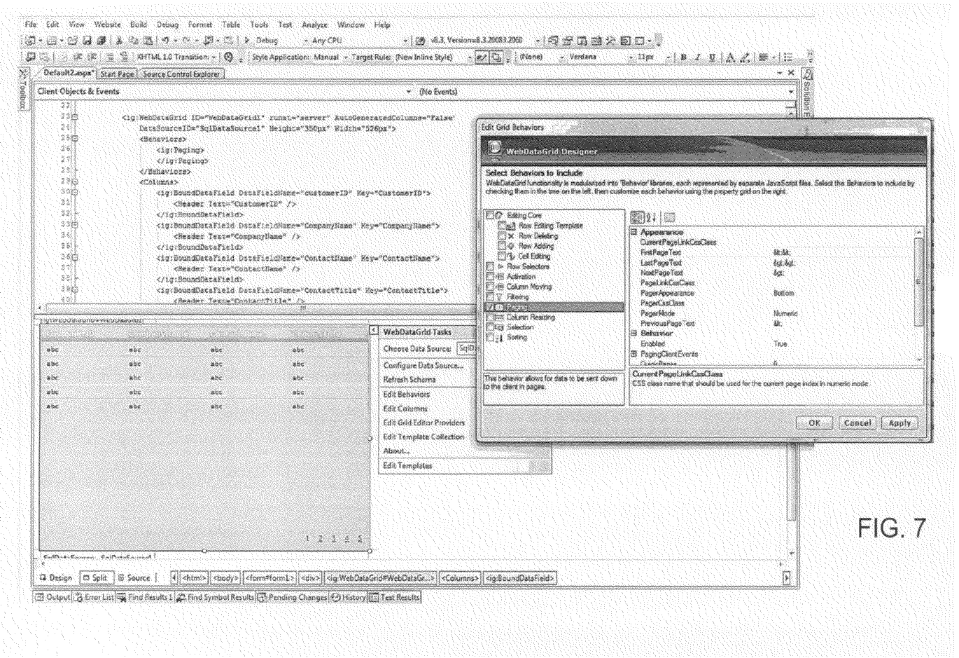

FIG. 7 is a illustration of an exemplary user interface for selecting functional modules to apply to a core control. A display shows the generated code for the composed control as the control is authored. A window is provided for the selection of the modules to apply to the control. As modules are selected, the composed control code is automatically updated to add calls to the newly added modules.

While the foregoing is directed to embodiments of the present invention, other and further embodiments of the invention may be devised without departing from the basic scope thereof, and the scope thereof is determined by the claims that follow.

1. A method for generating a composed control performed by a special-purpose computer programmed by a control designer application comprising:
selecting one or more functional modules to provide functionality to a core control;
coupling the one or more selected functional modules to the core control; and
generating scripted code that, when executed, implements the functionality of the core control coupled with the one or more selected functional modules.

2. The method of claim 1 wherein the functional modules are coupled to the core control at event points defined in the core control.

3. The method of claim 1 wherein the scripted code contains a minimum functionality comprised of the core control and the functional modules.

4. The method of claim 1 wherein the composable control is implemented in the ASP.net development framework.

5. The method of claim 1 wherein the selecting step is performed by choosing a behavior for the composed control and the behavior is implemented by one or more functional modules.

6. The method of claim 1 wherein a separate script is generated for each functional module and core control.

7. The method of claim 1 wherein a single script is generated comprising the functionality of all functional modules coupled to the core control.

8. The method of claim 1 further comprising authoring one or more of the selected functional modules.

9. The method of claim 1 further comprising:
selecting and coupling one or more sub-modules to the one or more selected functional modules and wherein the generated scripted code includes the functionality of the selected sub-modules.

10. A computer readable storage medium containing instructions that, when executed by a processor, cause the processor to implement a method of generating a composed control comprising:
selecting one or more functional modules to provide functionality to a core control;
coupling the one or more selected functional modules to the core control; and
generating scripted code that, when executed, implements the functionality of the core control coupled with the one or more selected functional modules.

11. The computer readable storage medium of claim 10 wherein the functional modules are coupled to the core control at event points defined in the core control.

12. The computer readable storage medium of claim 10 wherein the scripted code contains a minimum functionality comprised of the core control and the functional modules.

13. The computer readable storage medium of claim 10 wherein the composable control is implemented in the ASP.net development framework.

14. The computer readable storage medium of claim 10 wherein the selecting step is performed by choosing a behavior for the composed control and the behavior is implemented by one or more functional modules.

15. The computer readable storage medium of claim 10 wherein a separate script is generated for each functional module and core control.

16. The computer readable storage medium of claim 10 wherein a single script is generated comprising the functionality of all functional modules coupled to the core control.

17. The computer readable storage medium of claim 10 further comprising authoring one or more of the selected functional modules.

18. The computer readable storage medium of claim 10 further comprising:
selecting and coupling one or more sub-modules to the one or more selected functional modules and wherein the generated scripted code includes the functionality of the selected sub-modules.

19. A control architecture for implementing composable controls comprising:
a module selector for selecting one or more functional modules to add to a core control;
a control author for generating a composed control representing the selected functional modules coupled to the core control at one or more event points.

20. The control architecture of claim 19 further comprising a module author for developing additional functional modules.
